(19) United States
(12) Patent Application Publication
(10) Pub. No.: US 2025/0121455 A1
(43) Pub. Date: Apr. 17, 2025

(54) MULTI-LASER BEAM FOCUSING AND SCRIBING DEVICE WITH FOLLOWING FUNCTION, AND PROCESSING METHOD USING THE SAME

(71) Applicant: Shenzhen Qinghong Laser Technology Co., Ltd, Shenzhen (CN)

(72) Inventors: Kun GAO, Shenzhen (CN); Shuling YE, Shenzhen (CN); Cheng LI, Shenzhen (CN); Fan ZENG, Shenzhen (CN)

(21) Appl. No.: 18/989,551

(22) Filed: Dec. 20, 2024

(30) Foreign Application Priority Data
May 30, 2024 (CN) 202410683714.0

(51) Int. Cl. B23K 26/067; B23K 26/046; B23K 26/06; B23K 26/362; B23K 101/36; B23K 103/00

(52) U.S. Cl. CPC B23K 26/0673; B23K 26/046; B23K 26/0648; B23K 26/362; B23K 2101/36; B23K 2103/54

(57) ABSTRACT

A multi-laser beam focusing and scribing device with following function includes a beam splitter module, a focusing lens module, a first shaft, a diffractive optical element (DOE) beam shaping lens, a second adjustment shaft, a coaxial charge-coupled device (CCD) vision module, and a distance-measuring sensor. The first adjustment shaft is configured to adjust a focus position, and the second adjustment shaft is configured to adjust a spacing between scribed lines, and is electrically-powered. The beam splitter module is configured to split an incident laser beam into a plurality of sub-beams.

### CROSS-REFERENCE TO RELATED APPLICATIONS

This application claims the benefit of priority from Chinese Patent Application No. 202410683714.0, filed on May 30, 2024. The content of the aforementioned application, including any intervening amendments made thereto, is incorporated herein by reference in its entirety.

### TECHNICAL FIELD

The application relates to the field of laser processing and automatic control technology, and more particularly to a multi-laser beam focusing and scribing device with a following function.

### BACKGROUND

As the third-generation solar cells, thin-film solar cells have attracted considerable interest due to their excellent performances, and mainly include cadmium telluride (CdTe), copper indium gallium selenide (CIGS) and perovskite-based thin-film solar cells. The manufacturing process of thin-film solar cells includes three scribing steps (known as P1, P2 and P3), which all involve the laser scribing equipment. These scribing steps are extremely critical, which require the straightness and parallelism of P1, P2 and P3 scribes to reach the micron level. Precise scribing can effectively reduce the dead area, and is of great significance for improving the cell conversion efficiency. However, the laser scribing equipment accounts for a large proportion of the entire production investment. Therefore, how to design and develop a laser scribing system with excellent performance, high efficiency and low cost has become a top priority in the field of thin-film solar cells.

The glass substrates of thin-film solar cells are large in area. For example, for a glass substrate with a length of 2.4 m and a width of 1.2 m, more than 200 scribes may be created in a single P1 scribing step. Therefore, increasing the number of scribing beams in the scribing device or even integrating multiple scribing devices to simultaneously perform the scribing step has been considered as an optimal solution to improve the production efficiency.

Moreover, the insufficient number of laser beams in the existing scribing devices will lead to a larger dead area in the sub-cells.

### SUMMARY

The present disclosure provides a multi-laser beam focusing and scribing device with a following function and a processing method using the same, which can effectively satisfy the need of increasing the number of scribing beams within the scribing device or even integrate multiple scribing devices for simultaneous scribing, and also avoid forming a large dead area in sub-cells.

The present disclosure provides a multi-laser beam focusing and scribing device with a following function, comprising:
a beam splitter module;
a focusing lens module;
a first adjustment shaft;
a diffractive optical element (DOE) beam shaping lens;
a second adjustment shaft;
a coaxial charge-coupled device (CCD) vision module; and
a distance-measuring sensor;
wherein the first adjustment shaft is configured to adjust a focus position; and
the second adjustment shaft is configured to adjust a spacing between scribed lines, and is electrically-powered.

In an embodiment, the beam splitter module, the focusing lens module, the DOE beam shaping lens, the coaxial CCD vision module and the distance-measuring sensor are configured to be applicable to an ultraviolet femtosecond laser, an infrared picosecond laser, a green picosecond laser, an ultraviolet nanosecond laser and a green nanosecond laser;
the beam splitter module is configured to split an incident laser beam into a plurality of sub-beams; and a beam splitter of the beam splitter module is an analyzing crystal or a beam-splitting mirror;
the focusing lens module is configured to focusing 2-16 beams; and
the first adjustment shaft is electrically-powered, and is provided with a first moving and guiding mechanism; the second adjustment shaft is provided with a second moving and guiding mechanism; and the first moving and guiding mechanism and the second moving and guiding mechanism are each independently an air-bearing guide rail, a linear guide rail, an air bushing, or a combination thereof.

In an embodiment, the second adjustment shaft is configured to independently and electrically adjust a spacing between the plurality of sub-beams to adapt to laser scribing of a thin-film solar cell with a sub-cell spacing of 3-10 mm.

In an embodiment, the first adjustment shaft is configured to independently and electrically adjust a focal length of each of the plurality of sub-beams.

In an embodiment, the DOE beam shaping lens is configured to transform each of the plurality of sub-beams into a flat-top spot or multiple spots.

In an embodiment, the multi-laser beam focusing and scribing device is configured to have a focus following function and a trajectory following function;
the distance-measuring sensor is configured to monitor a distance from a surface of a to-be-processed product to the DOE beam shaping lens in real time, and the first adjustment shaft is configured to adjust a position of a focus formed by the plurality of sub-beams according to the distance to ensure that the focus is always on the surface of the to-be-processed product, so as to achieve the focus following function, wherein the distance-measuring sensor is a laser range-finder; and
the coaxial CCD vision module is configured to be coaxial with one of the plurality of sub-beams to monitor a distance between a reference line and one of the scribed lines adjacent to the reference line in real time, and the second adjustment shaft is configured to adjust a position of the one of the plurality of sub-beams to make the scribed lines remain parallel to the reference line, so as to achieve the trajectory following function, wherein the coaxial CCD vision module is a camera.

In an embodiment, the second adjustment shaft is configured to be driven by a linear motor, a voice coil motor, a stepper motor-lead screw combination, a servo motor-lead screw combination, or a motor-synchronous belt combination; and
the focusing lens module is provided on the first adjustment shaft; the second adjustment shaft is configured to be electrically driven to adjust a position of the first adjustment shaft and a position of the focusing lens module, so as to adjust a spacing between the plurality of sub-beams.

In an embodiment, the first adjustment shaft is configured to be driven by a linear motor, a voice coil motor, a stepper motor-lead screw combination, a servo motor-lead screw combination, or a motor-synchronous belt combination; and
the first adjustment shaft is configured to alter a focusing position of the plurality of sub-beams to adjust the focus.

In an embodiment, the focusing lens module comprises a plurality of focusing lenses; working distances of the plurality of focusing lenses are the same or different; and each of the plurality of focusing lenses has a working distance of 50-300 mm.

In an embodiment, the plurality of sub-beams are configured to be output downward to scribe a film surface of the to-be-processed product in response to a case that a laser is located above the to-be-processed product.

In an embodiment, the plurality of sub-beams are configured to be output upward to penetrate a glass substrate of the to-be-processed product for scribing in response to a case that a laser is located below the to-be-processed product.

The spacing and focal length of each laser can be independently and adjusted, allowing users to adjust the position and focus of the lasers according to specific needs. Since the adjustments are electrically-powered, they offer higher precision and repeatability compared to manual adjustments, which is especially important for scientific experiments or industrial production that require precise control of the positioning and focal length of the lasers. Independent electric adjustment significantly improves efficiency, reducing the time and labor costs associated with manual adjustments while also minimizing errors and instability caused by manual operations. Through DOE spot shaping technology, complex spot shapes such as flat-top spots or multiple spots can be achieved. This not only enriches the forms and functions of lasers but also expands their applications in fields like material processing, biomedicine, and optical communications. This approach makes the multi-laser beam focusing and scribing device easy to expand and modular. Users can conveniently increase or decrease the number of lasers and adjust their configurations and parameters to meet the evolving demands of research or production.

Multiple lasers enter the multi-laser beam focusing and scribing device in parallel along the height direction of the multi-laser beam focusing and scribing device. The number of incident lasers in this present disclosure can be flexibly set from 1 to 12 (and can be increased if necessary).

Firstly, the present disclosure will be explained using 4 incident lasers (labeled as a1 to a4) as an example. Each path of the incident lasers is sequentially provided with a DOE beam shaping lens, a beam splitter, and a reflecting mirror. The beam splitter divides the incident laser into two sub-beams. The 4 incident lasers pass through 4 sets of the beam splitters respectively and split into 8 sub-beams. Each of the 8 sub-beams then passes through a focusing lens and is focused onto the film surface of the to-be-processed product. The focusing lens is fixed on a movable plate, which is driven by a focus adjustment elevation shaft to move up and down, thus changing the vertical position of the focus of the sub-beam and allowing independent adjustment of the focus for each sub-beam. During the scribing process, a distance-measuring sensor quickly detects the height changes of the film surface of the to-be-processed product and feeds this information back to a control system. The control system then controls the focus adjustment elevation shaft to move rapidly and precisely adjust the vertical position of the focusing lens, ensuring that the focus of the sub-beam remains on the film surface of the to-be-processed product in real time, thus achieving the focal following function in the process of laser scribing.

The driving motor for the focus adjustment elevation shaft can include, but is not limited to, linear motors, voice coil motors, piezoelectric ceramic motors, servo motors, or stepper motors. The moving and guiding mechanism of the focus adjustment elevation shaft can adopt, but is not limited to, air-floating rails, magnetic levitation structures, linear guides, or linear bearings. Each focus adjustment elevation shaft is fixed to the corresponding electric line-spacing-adjustment shaft, with one focus adjustment elevation shaft corresponding to one set of electric line-spacing-adjustment shafts. For 8 sub-beams, eight sets of electric line-spacing-adjustment shafts need to be set up, arranged horizontally in the axial direction and stacked in the height direction of the multi-laser beam focusing and scribing device. The movement of the electric line-spacing-adjustment shafts changes the horizontal position of the focus adjustment elevation shaft, allowing for independent adjustment of the spacing between sub-beams. The moving and driving motor for the electric line-spacing-adjustment shaft can be selected from, but is not limited to, linear motors, voice coil motors, piezoelectric ceramic motors, servo motors, or stepper motors, with guiding mechanism that can include, but are not limited to, air-floating rails, magnetic levitation structures, linear guides, or linear bearings.

The coaxial CCD vision module is integrated into the laser optical path system through a beam splitter, sharing one focusing lens with one sub-beam to form a coaxial imaging system. The coaxial CCD vision module consists of a camera, an imaging collimating lens, a half-transparent and half-reflecting mirror, and a light source. During the scribing process, the coaxial CCD vision module continuously monitors the offset between the processing center point and the P1 line position within the imaging field. The control system manages the movement of the electric line-spacing-adjustment shaft to timely adjust the lateral position of the focus of each sub-beam, ensuring that the current scribing is as parallel as possible to the P1 line, thereby achieving the trajectory following function in the process of the laser scribing.

The present disclosure provides the following benefits.

The device achieves simultaneous scribing with multiple lasers, allowing to independently and electrically adjust the spacing between each laser and the focal length of each laser. The DOE beam shaping lens transforms the laser into a flat-top or multiple spots. Additionally, the device creatively integrates trajectory following and focal following functions, ensuring precise and stable scribing processes. This improves the parallelism of P2/P3 scribing relative to P1 scribing, effectively reducing the dead zone area of the sub-cells, thus achieving high-quality, high-efficiency scribing for thin-film solar cells. However, traditional scribing methods, whether laser or mechanical, lack trajectory following and focal following functions, making it impossible to achieve micron-level parallelism. Small spacing scribing easily leads to overlapping lines. To prevent this overlap, the dead zone area of the sub-cells must be increased, sacrificing the efficiency of the thin-film cells. As the dimensions of thin-film solar cells grow larger, reaching 1.2 meters in width and 2.4 meters in length, the processing area of scribing also expands. The deformation of the product and the flatness of the supporting surface make it difficult to maintain an ideal planar processing surface. Without a trajectory following function, the depth and width of the scribed lines will vary, lowering the quality of the scribing process.

Furthermore, the multi-laser beam focusing and scribing device provided in this present disclosure is compact. For example, the focusing and scribing device with 8 lasers has a width of ≤280 mm. For scribing along the long edge of a perovskite solar cell product with a width of 1 meter and a length of 2 meter, the system can integrate three scribing devices for simultaneous processing. For a perovskite solar cell product with a width of 1.2 meter and a length of 2.4 meter, the system can integrate four scribing devices for simultaneous processing, and so forth. Different configurations can be achieved by integrating various numbers of scribing devices based on the area of the solar cell products.

### BRIEF DESCRIPTION OF THE DRAWINGS

FIG. 1a is a schematic diagram of the multi-laser beam focusing and scribing device with a following function according to an embodiment of the present disclosure;

FIG. 1b is a schematic diagram of the multi-laser beam focusing and scribing device with a following function according to an embodiment of the present disclosure; and

FIG. 2 is an exterior view of the multi-laser beam focusing and scribing device with a following function according to an embodiment of the present disclosure.

### DETAILED DESCRIPTION OF EMBODIMENTS

The core of this present disclosure lies in the splitting of the lasers, shaping of the lasers, and independent adjustment of the focus of the lasers. The laser multiplication is achieved through beam splitters, and the position of the focus of the laser is flexibly adjusted in conjunction with focusing lenses and a moving plate. A distance-measuring sensor continuously monitors the height changes of the film surface of the to-be-processed product, and the control system quickly adjusts the position of the focusing lens based on the feedback of the height changes, ensuring that the focus of the laser consistently aligns with the film surface of the to-be-processed product, thus achieving precise and efficient laser scribing with focal following function.

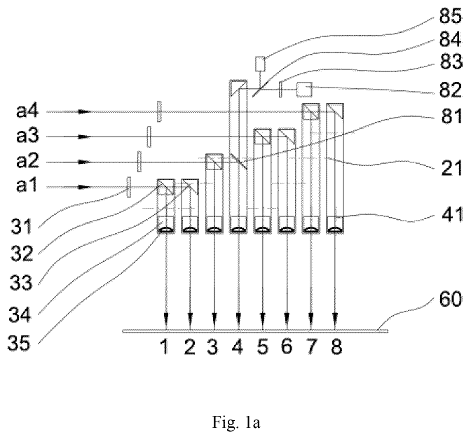

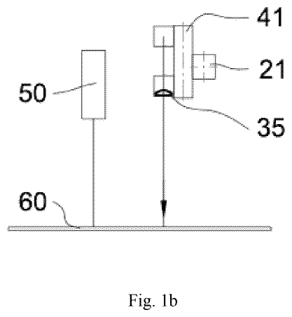

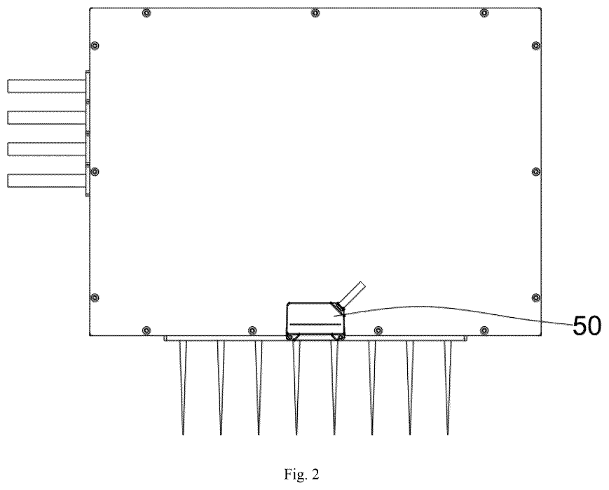

To better understand the above technical solution, the following detailed explanation will be provided in conjunction with the accompanying drawings and specific implementation methods. Referring to FIGS. 1a, 1b, and 2, the multi-laser beam focusing and scribing device with a following function provided in the present disclosure can be implemented as follows.

The multi-laser beam focusing and scribing device with following functions is configured as follows.

The multi-laser beam focusing and scribing device integrates a beam splitter module, a focusing lens module, a DOE beam shaping lens, a focus adjustment elevation shaft, an electric line-spacing-adjustment shaft, a coaxial CCD vision module and a distance-measuring sensor. The device achieves the scribing using multi-laser beams.

A processing method using the multi-laser beam focusing and scribing device with following functions is outlined as follows.

In Embodiment 1, using four incident lasers (labeled a1 to a4) as an example, each incident laser's optical path is sequentially provided with a DOE beam shaping lens 31, a beam splitter 32, and a reflecting mirror 33. The beam splitter 32 divides each of the 4 incident lasers into two portions. After passing through four beam splitters 32 respectively, the four incident lasers are transformed into eight sub-beams, which then pass through focusing lenses 35, focusing on the film surface of the to-be-processed product 60. The focusing lens 35 is fixed on a moving plate 34, which is driven vertically by a focus adjustment elevation shaft 41 to change the vertical position of the focus of the sub-beams, allowing for independent adjustment of the focus of each sub-beam. During the scribing process, a distance-measuring sensor 50 quickly detects changes in the height of the film surface of the to-be-processed product 60, feeding back to the control system, which controls the focus adjustment elevation shaft 41 to move swiftly and precisely adjust the vertical position of the focusing lens 35, ensuring that the focus of each of the sub-beams remains on the film surface of the to-be-processed product 60, thereby achieving the focal following function during the laser scribing. The driving motor for the focus adjustment elevation shaft 41 can include, but is not limited to, linear motors, voice coil motors, piezoelectric ceramic motors, servo motors, or stepper motors, and the guiding structure can be, but is not limited to, air floatation guides, magnetic levitation structures, linear guides, or linear bearings. Each focus adjustment elevation shaft 41 is fixed to its corresponding electric line-spacing-adjustment shaft 21; one focus adjustment elevation shaft corresponds to one set of electric line-spacing-adjustment shafts. Eight paths of the sub-beams corresponds to eight sets of electric line-spacing-adjustment shafts, arranged horizontally in the axial direction, with multiple sets aligned along the height direction of the multi-laser beam focusing and scribing device. The motion of the electric line-spacing-adjustment shaft 21 alters the lateral position of the focus adjustment elevation shaft 41, enabling independent adjustment of the spacing of the sub-beams. The moving and driving motor for the electric line-spacing-adjustment shaft can include, but is not limited to, linear motors, voice coil motors, piezoelectric ceramic motors, servo motors, or stepper motors, and moving and guiding mechanisms of the electric line-spacing-adjustment shaft can include, but are not limited to, air floatation guides, magnetic levitation structures, linear guides, or linear bearings.

The coaxial CCD vision module is integrated into the laser optical path system through a beam splitter 81, sharing one focusing lens with one sub-beam to form a coaxial imaging system. The coaxial CCD vision module consists of a camera 82, an imaging collimating lens 83, a half-transparent and half-reflecting mirror 84, and a light source 85. During the scribing process, the coaxial CCD vision module continuously monitors the offset between the processing center point and the P1 line position within the imaging field. The control system controls the movement of the electric line-spacing-adjustment shaft to timely adjust the lateral position of the focus of each sub-beam, ensuring that the current scribing is as parallel as possible to the P1 line, thereby achieving the trajectory following function in the process of the laser scribing.

In Embodiment 2, using three incident laser beams (labeled a1 to a3) as an example, each incident laser beam's optical path is sequentially equipped with a DOE beam shaping lens 31, beam splitter 32, and reflecting mirror 33. The beam splitter 32 divides each of the incident lights into two portions to obtain two sub-beams. After passing through three sets of beam splitters 32 respectively, the three laser beams are split into six sub-beams, each of which is then focused onto the film surface of the to-be-processed product 60 using a focusing lens 35. The line spacing adjustment and independent focal adjustment for each laser beam are implemented similarly to Embodiment 1, maintaining the focal following and trajectory following functions.

The eight sub-beams in Embodiment 1 and the six sub-beams in Embodiment 2, as well as other configurations of ten or twelve sub-beams, are determined based on a comprehensive assessment of the structure of the sub-battery of the to-be-processed product, the size of the to-be-processed product, and the requirement of the processing efficiency. For instance, the multi-laser beam focusing and scribing device with eight sub-beams, with a width of ≤280 mm, integrates three scribing devices for simultaneous scribing on the long side of a perovskite battery product measuring 1 meter wide and 2 meters long. For a perovskite battery product measuring 1.2 meters wide and 2.4 meters long, the multi-laser beam focusing and scribing device can integrate four scribing devices for simultaneous processing. This can be adjusted accordingly for battery products of various sizes by integrating different numbers of scribing devices.

Although the preferred embodiments of the present application have been described, those skilled in the art may make various changes and modifications once they are aware of the fundamental inventive concepts. Therefore, the appended claims are intended to encompass both the preferred embodiments and all changes and modifications that fall within the scope of the present application defined by the appended claims.

Clearly, those skilled in the art can make various modifications and variations to the present application without departing from the spirit and scope of this present disclosure. Thus, if such modifications and variations of the present application fall within the scope of the claims and their equivalent technologies, the present application also intends to include these changes and variations.

What is claimed is:

1. A multi-laser beam focusing and scribing device with a following function, comprising:
a beam splitter module;
a focusing lens module;
a first adjustment shaft;
a diffractive optical element (DOE) beam shaping lens;
a second adjustment shaft;
a coaxial charge-coupled device (CCD) vision module; and
a distance-measuring sensor;
wherein the first adjustment shaft is configured to adjust a focus position; and
the second adjustment shaft is configured to adjust a spacing between scribed lines, and is electrically-powered.

2. The multi-laser beam focusing and scribing device of claim 1, wherein the beam splitter module, the focusing lens module, the DOE beam shaping lens, the coaxial CCD vision module and the distance-measuring sensor are configured to be applicable to an ultraviolet femtosecond laser, an infrared picosecond laser, a green picosecond laser, an ultraviolet nanosecond laser and a green nanosecond laser;
the beam splitter module is configured to split an incident laser beam into a plurality of sub-beams; and a beam splitter of the beam splitter module is an analyzing crystal or a beam-splitting mirror;
the focusing lens module is configured to focusing 2-16 beams; and
the first adjustment shaft is electrically-powered, and is provided with a first moving and guiding mechanism; the second adjustment shaft is provided with a second moving and guiding mechanism; and the first moving and guiding mechanism and the second moving and guiding mechanism are each independently an air-bearing guide rail, a linear guide rail, an air bushing, or a combination thereof.

3. The multi-laser beam focusing and scribing device of claim 2, wherein the second adjustment shaft is configured to independently and electrically adjust a spacing between the plurality of sub-beams to adapt to laser scribing of a thin-film solar cell with a sub-cell spacing of 3-10 mm.

4. The multi-laser beam focusing and scribing device of claim 3, wherein the first adjustment shaft is configured to independently and electrically adjust a focal length of each of the plurality of sub-beams.

5. The multi-laser beam focusing and scribing device of claim 4, wherein the DOE beam shaping lens is configured to transform each of the plurality of sub-beams into a flat-top spot or multiple spots.

6. The multi-laser beam focusing and scribing device of claim 1, wherein the multi-laser beam focusing and scribing device is configured to have a focus following function and a trajectory following function;
the distance-measuring sensor is configured to monitor a distance from a surface of a to-be-processed product to the DOE beam shaping lens in real time, and the first adjustment shaft is configured to adjust a position of a focus formed by the plurality of sub-beams according to the distance to ensure that the focus is always on the surface of the to-be-processed product, so as to achieve the focus following function, wherein the distance-measuring sensor is a laser range-finder; and
the coaxial CCD vision module is configured to be coaxial with one of the plurality of sub-beams to monitor a distance between a reference line and one of the scribed lines adjacent to the reference line in real time, and the second adjustment shaft is configured to adjust a position of the one of the plurality of sub-beams to make the scribed lines remain parallel to the reference line, so as to achieve the trajectory following function, wherein the coaxial CCD vision module is a camera.

7. The multi-laser beam focusing and scribing device of claim 6, wherein the second adjustment shaft is configured to be driven by a linear motor, a voice coil motor, a stepper motor-lead screw combination, a servo motor-lead screw combination, or a motor-synchronous belt combination; and
the focusing lens module is provided on the first adjustment shaft; the second adjustment shaft is configured to be electrically driven to adjust a position of the first adjustment shaft and a position of the focusing lens module, so as to adjust a spacing between the plurality of sub-beams.

8. The multi-laser beam focusing and scribing device of claim 6, wherein the first adjustment shaft is configured to be driven by a linear motor, a voice coil motor, a stepper motor-lead screw combination, a servo motor-lead screw combination, or a motor-synchronous belt combination; and
the first adjustment shaft is configured to alter a focusing position of the plurality of sub-beams to adjust the focus.

9. The multi-laser beam focusing and scribing device of claim 1, wherein the focusing lens module comprises a plurality of focusing lenses; working distances of the plurality of focusing lenses are the same or different; and each of the plurality of focusing lenses has a working distance of 50-300 mm.

10. The multi-laser beam focusing and scribing device of claim 6, wherein the plurality of sub-beams are configured to be output downward to scribe a film surface of the to-be-processed product in response to a case that a laser is located above the to-be-processed product.

11. The multi-laser beam focusing and scribing device of claim 6, wherein the plurality of sub-beams are configured to be output upward to penetrate a glass substrate of the to-be-processed product for scribing in response to a case that a laser is located below the to-be-processed product.
